(19) United States
(12) Patent Application Publication
(10) Pub. No.: US 2024/0174271 A1
(43) Pub. Date: May 30, 2024

(54) Composite Railcar Floor Assembly

(71) Applicant: Trinity North American Freight Car, Inc., Dallas, TX (US)

(72) Inventors: Daniel G. Cortez, Grapevine, TX (US); Kenneth W. Huck, Fairview, TX (US)

(21) Appl. No.: 18/509,389

(22) Filed: Nov. 15, 2023

Related U.S. Application Data
(60) Provisional application No. 63/385,050, filed on Nov. 28, 2022.

(51) Int. Cl. B61D 17/10; B61D 17/18; B61D 49/00; B61F 1/08

(52) U.S. Cl. CPC B61D 17/10; B61D 17/18; B61D 49/00; B61F 1/08

(57) ABSTRACT

A railcar comprises a composite floor assembly. The composite floor assembly comprises a plurality of channels disposed on top of an underframe and longitudinally extending along a length of the composite floor assembly. Each of the plurality of channels forms a recessed portion to allow the flow of liquid. The composite floor assembly further comprises an integral drain pan integrated into the composite floor assembly such that the integral drain pan forms a recessed portion along the longitudinal end of the composite floor assembly. The integral drain pan is configured to accumulate the liquid flown from the plurality of channels.

### PRIORITY

This application claims priority to U.S. Provisional Patent Application No. 63/385,050 filed Nov. 28, 2022 and titled “Composite Railcar Floor Assembly,” which is incorporated herein by reference.

### TECHNICAL FIELD

This disclosure relates generally to railcars and, more particularly, to a composite railcar floor assembly.

### BACKGROUND

Railroad box railcars transport a variety of commodities held in a variety of railcar internal environments. In some cases, liquid from the commodity, cleaning liquid, or debris from exposure to the outside may be found or accumulated on the floor of the boxcar. If not removed, the accumulated liquid or debris will linger and cause loading and unloading of commodities difficult.

### SUMMARY

To address the foregoing problems, various embodiments are disclosed herein for providing a composite floor assembly for box railcars. The composite floor assembly includes a drain pan that is integrated into a primary floor of a railcar. For example, during the construction of the composite floor assembly, the primary floor may be formed with a recessed portion at one (or both) end(s) of the primary floor that forms the drain pan. Therefore, no additional parts are required to provide the feature of collecting runoff liquid (e.g., liquid from the commodity carried by the railcar or cleaning liquid) or debris from the railcar floor.

When the primary floor composite is installed, no additional caulking or sealing is required for the drain pan. This leads to eliminating additional labor and scaling degradation and maintenance for the drain pan. This also eliminates having to design, procure, install, and insulate a separate part in addition to the primary floor.

Certain embodiments may provide one or more technical advantages. In some embodiments, the composite floor assembly provides a more efficient railcar floor design that leads to a reduction in design complexity, materials (e.g., caulking or sealing materials), and labor installation. The drain pan being integral to the floor leads to little or no chance of developing leakages, such as through sealant degradation over time or improper installation, or reduced maintenance. Furthermore, since the drain pan is a part of the composite floor assembly, it is already insulated from the outside environment, eliminating potential degradation over time and use. This may also reduce greenhouse gas emissions by eliminating foam application under and around the drain pan.

In some embodiments, the composite floor assembly also provides improvements to the performance and maintenance of the railcars. For example, by implementing the composite floor assembly, liquid and debris can be removed from the railcar easier, more frequently, more efficiently, and faster without incurring additional cleaning time or labor. This leads to maintaining the floor of the railcar free of obstacles which helps during the loading and unloading of commodities to and from the railcar. Furthermore, frequent debris removal that may cause damage to the railcar floor over time increases the railcar's life span.

Several embodiments are elaborated on in this disclosure. In accordance with a particular embodiment, a railcar includes a composite floor assembly. The composite floor assembly comprises an underframe, a plurality of channels, and an integral drain pan. The plurality of channels is disposed on top of the underframe and longitudinally extending along a length of the composite floor assembly. Each of the plurality of channels forms a recessed portion to allow the flow of liquid. The integral drain pan is integrated into the underframe such that the integral drain pan forms a recessed portion along the longitudinal end of the composite floor assembly. The integral drain pan is configured to accumulate the liquid that flown from the plurality of channels.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a side view of a railcar;

FIG. 2 illustrates an isometric view of an embodiment of a composite railcar floor assembly;

FIG. 3 illustrates a cross-section view of an embodiment of a composite railcar floor assembly;

FIG. 4A illustrates an isometric view of an embodiment of a sloped edge for a drain pan; and

FIG. 4B illustrates an isometric view of an embodiment of a drain pan with a sloped edge.

### DETAILED DESCRIPTION

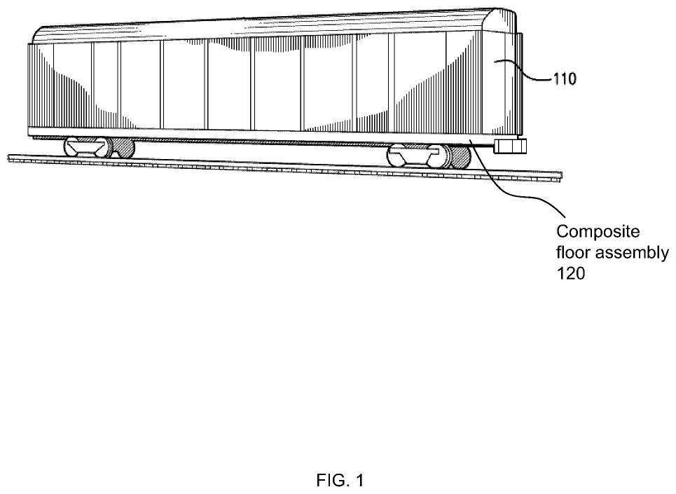

FIG. 1 illustrates an exemplary railcar 110. Examples of a railcar 110 include, but are not limited to, a box car, an auto rack car, a shipping railcar, an over-the-road box truck, a van, and a trailer. Railcar 110 is used to transport goods or commodities. Refrigerated and insulated box railcars 110 may be used where the commodities require certain parameters to maintain the quality and integrity of the goods shipped. Refrigerated box railcars 110 may be used to transport frozen products or fresh produce that require controlled temperature and humidity levels. Insulated box railcars 110 may be used to transport fresh produce or types of liquid where the internal boxcar temperature is controlled by the internal loading temperature of the boxcar, the temperature of the commodity, and the insulation performance of the boxcar.

In some cases, liquid from the commodity, cleaning liquid, or debris from exposure to the outside may be found or aggregated on the floor of the boxcar. In some cases, a drain pan can be installed by a technician at the edge of the floor to collect the accumulated liquid or debris. At the edge of the floor, runoff liquid or debris is collected in the drain pan that has drains that can be opened to remove the accumulated liquid or debris from the railcar. The drain pan installation can take place before or after the primary floor installation but must be sealed to the floor and railcar to prevent inadvertent leaks. The current drain pan installation techniques require additional and unique designs for the drain pan, suppliers, logistics, and installation labor in addition to the floor installation. This leads to increased complexity in the designs of floors and drain pans and additional procedures to install the drain pans. Even with taking precautions during the drain pan installation process, there is always the potential for leakage from the sides of the drain pan that is not properly sealed to the floor or from where the sealant is worn off. This leads to constant sealing maintenance for the drain pan.

The present disclosure contemplates a drain pan that is integrated into the primary floor of the railcar 110—meaning that the floor of the railcar 110 is constructed to have the drain pan at one or more edges. In this way, no additional material (such as a separate drain pan) is needed to be installed at the edge of the floor. This leads to more effective removal of accumulated liquid and debris from the floor of the railcar 110. Furthermore, since the drain pan is a part of the primary floor, no additional caulking or sealing is required for the drain pan. Other advantages of the present disclosure are described further below. The description below describes certain components of the railcar 110.

As can be seen in FIG. 1, the railcar 110 includes a composite floor assembly 120 where the body of the railcar 110 sits on. The composite floor assembly 120 may be mounted on an underframe of the railcar 110.

The composite floor assembly 120 is generally configured to provide a primary floor for the interior of the railcar 110. Commodity carried by the railcar 110 can be placed on top of the composite floor assembly 120. The composite floor assembly 120 is further configured to provide the feature of collecting and disposing of liquid (e.g., the liquid from the commodity or the cleaning liquid), debris from exposure to the outside environment, or anything else remaining on the floor that needs to be removed.

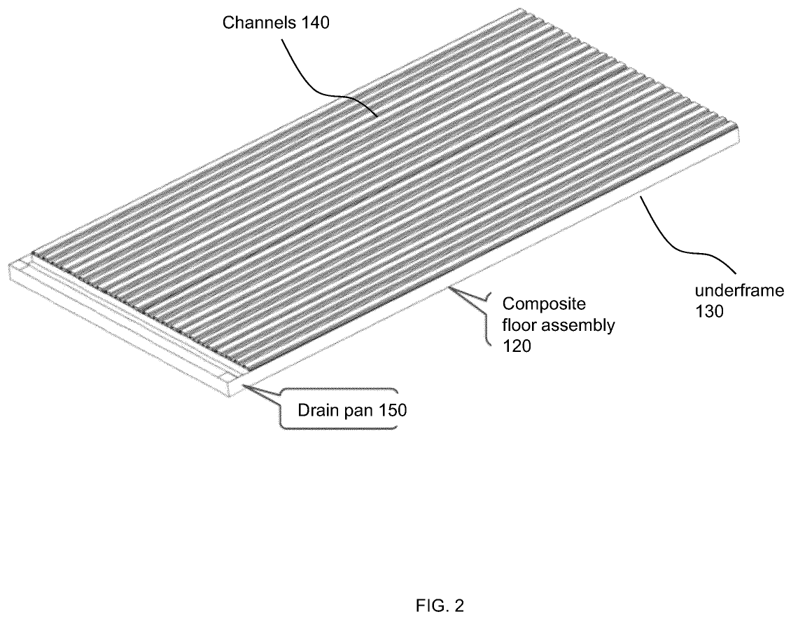

FIG. 2 illustrates an isometric view of an embodiment of the composite floor assembly 120. In the illustrated embodiment, the composite floor assembly 120 includes an underframe 130, a plurality of channels 140, and a drain pan 150. In other embodiments, composite floor assembly 120 may not have all of the components listed and/or may have other elements instead of, or in addition to, those listed above.

Underframe 130 may generally include structural members that extend laterally and longitudinally to provide structural support for the composite floor assembly 120. The composite floor assembly 120 sits on top of and is attached to the underframe 130. In certain embodiments, the underframe 130 may be formed by steel alloy or other metal alloys.

Channels 140 may be disposed on top of the underframe 130 and generally form recessed portions to allow the flow of liquid, debris or anything else remaining on the floor that needs to be removed. The channels 140 may longitudinally extend along the length of the composite floor assembly 120. The composite floor assembly 120 may include any number of channels 140. The dimension (e.g., width and height) of a channel 140 may be determined such that it can accommodate the flow of liquid and/or debris without causing an obstruction in the channel 140.

Drain pan 150 may be formed during the construction of the primary composite floor assembly 120. The drain pan 150 is integrated into the primary composite floor assembly 120 such that the integral drain pan 150 forms a recessed portion along the longitudinal end of the primary composite floor assembly 120. In some embodiments, the drain pan 150 may be integrated into the primary composite floor assembly 120 at one or more ends or sides of the primary composite floor assembly 120. For example, during construction of the primary composite floor assembly 120, the primary floor may be formed with a recessed portion at one or more longitudinal end(s) that forms the drain pan 150. In some embodiments, the drain pan 150 may be integrated into the primary composite floor assembly 120 anywhere along the length of the primary composite floor assembly 120 with floor extending on either side of the drain pan 150. For example, during construction of the primary composite floor assembly 120, the primary floor may be formed with a recessed portion anywhere and/or width of the length of the primary composite floor assembly 120. Therefore, no additional parts are required to provide the feature of collecting runoff liquid (e.g., liquid from the commodity carried by the railcar or cleaning liquid) or debris from the railcar. This is unlike the current floor assemblies. In the current floor assemblies, a drain pan is installed before or after the primary floor is installed. Furthermore, in the current floor assemblies, the drain pan is separate from the floor and needs to be sealed to the floor to prevent leakage which needs additional sealing maintenance. This disclosure contemplates an unconventional composite floor assembly 120 where the drain pan 150 is integrated into the primary composite floor assembly 120 obviating a need for an additional component (e.g., drain pan), material, or sealing maintenance. When the primary composite floor 120 integrated with the drain pan 150 is installed, no additional caulking or sealing is required for the drain pan 150. This leads to eliminating additional labor and scaling degradation and maintenance for the drain pan. This also eliminates having to design, procure, install, and insulate a separate part in addition to the primary floor.

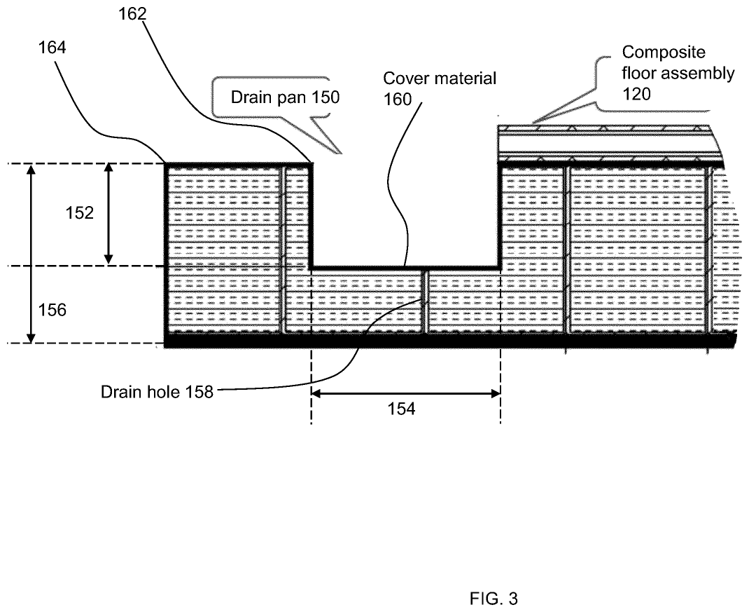

As shown in FIG. 2, the drain pan 150 may longitudinally extend along the end of the composite floor assembly 120. In other embodiments, the drain pan 150 may have a smaller longitudinal length than the longitudinal length of the composite floor assembly 120. In the illustrated embodiment, the drain pan 150 is formed on one end of the composite floor assembly 120. In certain embodiments, the drain pan 150 may be formed on both ends of the composite floor assembly 120. In certain embodiments, the drain pan 150 may be formed on one or more sides of the composite floor assembly 120. In certain embodiments, the drain pan 150 may be formed anywhere along the length and of the primary composite floor assembly 120 with floor extending on either side of the drain pan 150. The drain pan 150 is configured to accumulate the liquid and/or debris that flown along the channels 140. Drain holes (158 in FIG. 3) may be drilled at the bottom of the drain pan 150 to allow the release of the liquid and/or debris accumulated in the drain pan 150.

In certain embodiments, the composite floor assembly 120 may be a one-piece composite floor with the drain pan(s) 150 on one or more end(s) or anywhere along the length of the composite floor assembly 120. In the one-piece composite floor assembly 120, the flooring structure is uninterrupted. Within this configuration, based on the design choice, the drain pan(s) 150 may be formed at one or more ends or at any location along the length of the composite floor assembly 120. For example, the drain pan(s) 150 may be formed at designated high-risk spill zones or evenly distributed along the length to facilitate comprehensive liquid containment and drainage capabilities throughout the flooring surface.

In certain embodiments, the composite floor assembly 120 may be a two-piece composite floor with drain pan(s) 150 on one end of each piece. In this configuration, each piece of the composite floor assembly 120 comprises its own integrated drain pan(s) 150 situated at one end of each piece. This configuration may be suitable for modular or sectional flooring systems, where each piece can be independently positioned and installed, and the drain pan(s) 150 manage spillage or liquid waste for each piece. The two-piece composite floor assembly 120 configuration offers modularity which enables tailored solutions for various flooring layouts and dimensions.

Certain embodiments may provide one or more technical advantages. In some embodiments, the composite floor assembly 120 provides a more efficient railcar floor design that leads to a reduction in design complexity, materials (e.g., caulking or scaling materials), and labor installation.

The drain pan 150 being integral with the primary floor leads to little or no chance of developing leakages, such as through sealant degradation over time or improper installation, or reducing maintenance. Furthermore, since the drain pan 150 is a part of the composite floor assembly 120, insulating the composite floor assembly 120 and the drain pan 150 can be achieved by covering both the composite floor assembly 120 and the drain pan 150 with a cover material (160 in FIG. 3) that insulates the composite floor assembly 120 and the drain pan 150 from the outside environment, eliminating potential degradation over time and use. This may also reduce greenhouse gas emissions by eliminating foam application under and around the drain pan 150.

In some embodiments, the composite floor assembly 120 also provides improvements to the performance and maintenance of the railcars. For example, by implementing the composite floor assembly 120, liquid and debris can be removed from the railcar easier, more frequently, more efficiently, and faster without incurring additional cleaning time or labor. This leads to maintaining the floor of the railcar free of obstacles which helps during the loading and unloading commodities to and from the railcar. Furthermore, frequent debris removal that may cause damage to the railcar floor over time increases the railcar's life span.

FIG. 3 illustrates a cross-sectional view of an embodiment of the composite floor assembly 120. As can be seen in FIG. 3, the drain pan 150 has a height 152 and a width 154. The height 152 may be less than the height 156 of the composite floor assembly 120. The height 152 may be in the order of one to several inches. The width 154 may be in the order of one or several inches. Drain holes 158 may be drilled at the bottom of the drain pan 150 to allow the release of the liquid and/or debris accumulated in the drain pan 150. Any number of drain holes 158 may be made at the bottom of the drain pan 150 at any suitable distance from each other.

In certain embodiments, a portion of the composite floor assembly 120 may extend between the edge 162 of the drain pan 150 and the edge 164 of the floor, where the portion of the composite floor assembly 120 between edges 162 and 164 provides support to the composite floor assembly 120 stay on top of the underframe. The length of the portion between the edges 162 and 164 may be in the order of one to several inches.

As shown in FIG. 3, the composite floor assembly 120 is covered by a cover material 160. The cover material 160 is configured to provide thermal insulation to the composite floor assembly 120. The cover material 160 may be formed from reinforcing fibers. For example, cover material 160 may be formed from fiberglass, carbon fiber members, cellulose fiber members, polymer fiber members, or a combination thereof. In certain embodiments, the cover material 160 may be in the form of a fabric that is also impregnated or coated with resin. In certain embodiments, the cover material 160 may include resin-infused fiberglass cloth, a coating material, and the like. This disclosure contemplates that the fiber material may be in various forms, such as chopped, woven, or non-woven, for example. In certain embodiments, the cover material 160 may be formed from multiple reinforcing layers, stacked together, and used in combination.

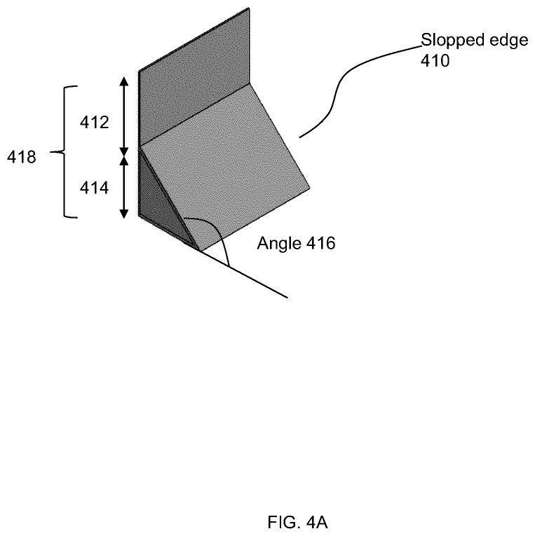

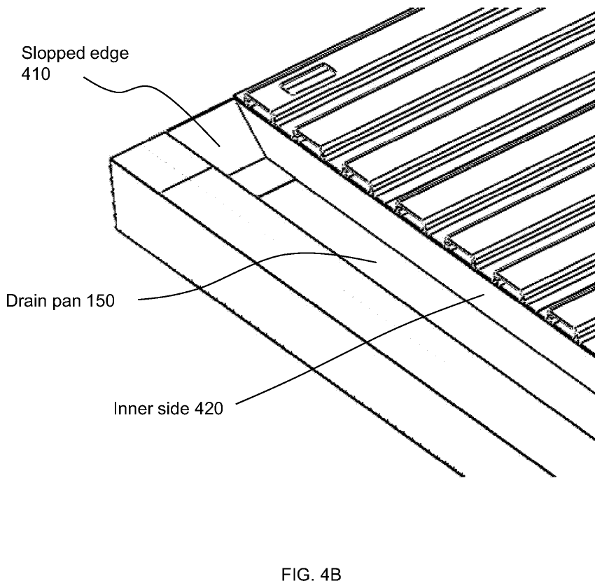

FIG. 4A illustrates an isometric view of an embodiment of a sloped wall or edge 410 for a drain pan (150 in FIG. 3). In certain embodiments, the drain pan (150 in FIG. 3) may be formed to have edge(s) on one or more of its side walls similar to the sloped edge 410 illustrated in FIG. 4A. As can be seen in FIG. 4A, the sloped edge 410 may have a height 414, and the rest of the side wall of the drain pan (150 in FIG. 3) may have a height 412. The addition of the heights 412 and 414 corresponds to the height 418 which is the total height of the drain pan (152 of 150 in FIG. 3). In certain embodiments, the height 414 of the sloped edge 410 may be more than, equal to, or less than the height 412 of the rest of the side wall of the drain pan (150 in FIG. 3). In some examples, each of the heights 412 and 414 may have a range from one to several inches. In certain embodiments, the height 418 of the sloped edge 410 may correspond to the total height 418 of the drain pan (150 in FIG. 3). For example, in such embodiments, the sloped edge 410 may start from the top of the height 418 and end at the bottom of the height 418.

In certain embodiments, the sloped edge 410 may form any suitable angle 416 with the bottom surface of the drain pan (150 in FIG. 3), such as 120 degrees, 130 degrees, etc.

FIG. 4B illustrates an example embodiment of the drain pan 150 with a sloped edge 410. In the illustrated embodiment, the drain pan 150 is shown with the sloped edge 410 at one end. The drain pan 150 may also have a similar sloped edge 410 at the opposite end (not explicitly shown).

In certain embodiments, the sloped edge 410 may be used on the inner side(s) 420 of the drain pan (150 in FIG. 3). In certain embodiments, the sloped edge 410 may be used on outboard edges of the drain pan (150 in FIG. 3), such as edges on lateral ends of the drain pan (150 in FIG. 3). The sloped edge 410 may point inward toward the center of the bottom of the drain pan (150 in FIG. 3) to direct the liquid and/or debris toward the drain holes at the bottom of the drain pan (150 in FIG. 3).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A railcar comprising:
a composite floor assembly, the composite floor assembly comprising:
an underframe;
a plurality of channels disposed on top of the underframe and longitudinally extending along a length of the underframe, wherein each of the plurality of channels forms a recessed portion to allow flow of liquid; and
an integral drain pan integrated into the composite floor assembly such that the integral drain pan forms a recessed portion within the composite floor assembly, wherein the integral drain pan is configured to accumulate the liquid that flown from the plurality of channels.

2. The railcar of claim 1, wherein the integral drain pan has a first height that is less than a second height of the underframe.

3. The railcar of claim 1, wherein the integral drain pan comprises a plurality of holes at a bottom of the integral drain pan to allow release of the liquid accumulated in the integral drain pan.

4. The railcar of claim 1, wherein the integral drain pan is covered with a cover material that provides thermal insulation.

5. The railcar of claim 4, wherein the cover material is resin infused fiberglass cloth.

6. The railcar of claim 1, wherein the integral drain pan has a smaller longitudinal length than the composite floor assembly.

7. The railcar of claim 1, wherein the integral drain pan is formed to have a sloped edge on at least one side of the integral drain pan.

8. The railcar of claim 1, wherein the integral drain pan is formed to have a sloped edge with a height less than a height of the integral drain pan.

9. The railcar of claim 1, wherein the integral drain pan is formed to have a sloped edge with a height that corresponds to a height of the integral drain pan.

10. The railcar of claim 4, wherein the integral drain pan is at a longitudinal end of the composite floor assembly or at a location along a length of the composite floor assembly with the composite floor extending on either side of the integral drain pan.

11. A composite floor assembly comprising:
an underframe;
a plurality of channels disposed on top of the underframe and longitudinally extending along a length of the underframe, wherein each of the plurality of channels forms a recessed portion to allow flow of liquid; and
an integral drain pan integrated into the composite floor assembly such that the integral drain pan forms a recessed portion within the composite floor assembly, wherein the integral drain pan is configured to accumulate the liquid that flown from the plurality of channels.

12. The composite floor assembly of claim 11, wherein the integral drain pan has a first height that is less than a second height of the underframe.

13. The composite floor assembly of claim 11, wherein the integral drain pan comprises a plurality of holes at a bottom of the integral drain pan to allow release of the liquid accumulated in the integral drain pan.

14. The composite floor assembly of claim 11, wherein the integral drain pan is covered with a cover material that provides thermal insulation.

15. The composite floor assembly of claim 14, wherein the cover material is resin infused fiberglass cloth.

16. The composite floor assembly of claim 11, wherein the integral drain pan has a smaller longitudinal length than the composite floor assembly.

17. The composite floor assembly of claim 11, wherein the integral drain pan is formed to have a sloped edge on at least one side of the integral drain pan.

18. The composite floor assembly of claim 11, wherein the integral drain pan is formed to have a sloped edge with a height less than a height of the integral drain pan.

19. The composite floor assembly of claim 11, wherein the integral drain pan is formed to have a sloped edge with a height that corresponds to a height of the integral drain pan.

20. The composite floor assembly of claim 14, wherein the integral drain pan is at a longitudinal end of the composite floor assembly or at a location along a length of the composite floor assembly with the composite floor extending on either side of the integral drain pan.
